(19) United States
(12) Patent Application Publication
(10) Pub. No.: US 2024/0038422 A1
(43) Pub. Date: Feb. 1, 2024

(54) NON-ORIENTED ELECTRICAL STEEL SHEET AND METHOD FOR MANUFACTURING SAME

(71) Applicant: POSCO Co., Ltd, Pohang-si, Gyeongsangbuk-do (KR)

(72) Inventors: Hunju LEE, Pohang-si, Gyeongsangbuk-do (KR); Yongsoo KIM, Pohang-si, Gyeongsangbuk-do (KR); Suyong SHIN, Pohang-si, Gyeongsangbuk-do (KR)

(73) Assignee: POSCO Co., Ltd, Pohang-si, Gyeongsangbuk-do (KR)

(21) Appl. No.: 18/268,387

(22) PCT Filed: Dec. 17, 2021
(86) PCT No.: PCT/KR2021/019338

§ 371 Date: Jun. 20, 2023

(30) Foreign Application Priority Data
Dec. 21, 2020 (KR) 10-2020-0179458

(51) Int. Cl. H01F 1/147; C22C 38/14; C22C 38/12; C22C 38/06; C22C 38/04; C22C 38/02; C22C 38/00; C21D 9/46; C21D 8/12; C21D 6/00; C21D 1/18; C21D 1/74

(52) U.S. Cl. CPC H01F 1/14766; C22C 38/14; C22C 38/12; C22C 38/06; C22C 38/04; C22C 38/02; C22C 38/004; C22C 38/002; C22C 38/001; C21D 9/46; C21D 8/1222; C21D 8/1233; C21D 8/1261; C21D 8/1272; C21D 6/005; C21D 6/008; C21D 1/18; C21D 1/74; C22C 2202/02

(57) ABSTRACT

A non-oriented electrical steel sheet according to an exemplary embodiment of the present invention includes 3.3 to 4.0 weight % of Si; 0.4 to 1.5 weight % of Al; 0.2 to 1.0 weight % of Mn; 0.0015 to 0.0040 weight % of C; 0.0005 to 0.0020 weight % of N; 0.0005 to 0.0025 weight % of S; 0.005 to 0.01 weight % of Mo; 0.0005 to 0.0020 weight % of Ti; 0.0005 to 0.0020 weight % of Nb; and 0.0005 to 0.0020 weight % of V, with the remainder including Fe and other unavoidable impurities.

### TECHNICAL FIELD

An exemplary embodiment of the present invention relates to a non-oriented electrical steel sheet and a method for manufacturing the same. Specifically, an exemplary embodiment of the present invention relates to a non-oriented electrical steel sheet that suppresses the formation of fine carbonitrides by appropriately adding Mo, Ti, Nb, and V, and controlling the time in a specific temperature range in a cooling process after final annealing, and a method for manufacturing the same. As a result, the present invention relates to a non-oriented electrical steel sheet with excellent magnetism and strength and a method for manufacturing the same.

### BACKGROUND ART

A non-oriented electrical steel sheet is mainly used in motors that convert electrical energy into mechanical energy, and requires excellent magnetic properties of the non-oriented electrical steel sheet to exhibit high efficiency in this process. In particular, recently, as eco-friendly vehicles driven by motors instead of internal combustion engines have attracted attention, the demand for the non-oriented electrical steel sheet used as a core material for a driving motor is increasing, and to this end, there is a demand for a non-oriented electrical steel sheet having both excellent magnetic properties and strength.

The magnetic properties of the non-oriented electrical steel sheet are mainly evaluated by iron loss and magnetic flux density. The iron loss means energy loss that occurs at specific magnetic flux density and frequency, and the magnetic flux density means the degree of magnetization obtained under a specific magnetic field. The lower the iron loss, the motor with higher energy efficiency may be manufactured under the same condition, and the higher the magnetic flux density, the smaller the motor or the lower copper loss. Therefore, it is possible to make a drive motor with excellent efficiency and torque by using a non-oriented electrical steel sheet with low iron loss and high magnetic flux density, thereby improving the mileage and output of an eco-friendly vehicle.

The characteristics of the non-oriented electrical steel sheet to be considered according to an operating condition of the motor also vary. As a general criterion for evaluating the characteristics of the non-oriented electrical steel sheet used in a motor, W15/50, which is iron loss when a 1.5 T magnetic field is applied at a commercial frequency of 50 Hz, has been widely used. However, in non-oriented electrical steel sheets with a thickness of 0.35 mm or less used in drive motors of eco-friendly vehicles, magnetic properties are often important at low fields of 1.0 T or less and high frequencies of 400 Hz or more, and thus, W10/400 iron loss is often used to evaluate the properties of the non-oriented electrical steel sheets.

The non-oriented electrical steel sheets for driving motors of eco-friendly vehicles require excellent strength as much as magnetic properties. The drive motors for the eco-friendly vehicles are mainly designed in the form of a permanent magnet inserted into a rotor, but in order for permanent magnet-inserted motors to exhibit excellent performance, the permanent magnets need to be located outside the rotor so as to be as close to the stator as possible. However, if the strength of the electrical steel sheet is low when the motor rotates at high speed, the permanent magnet inserted into the rotor may be separated by centrifugal force, and thus, an electrical steel sheet having high strength is required to secure the performance and durability of the motor.

A method commonly used to simultaneously increase the magnetic properties and strength of the non-oriented electrical steel sheet is to add an alloy element of Si, Al, Mn, or the like. If the resistivity of the steel is increased through the addition of these alloy elements, the eddy current loss may be reduced, thereby lowering the total iron loss. In addition, the alloy element is employed as a substitutional element to iron to cause a strengthening effect, thereby increasing the strength. On the other hand, as the added amount of alloy element such as Si, Al, and Mn increases, there is a disadvantage that the magnetic flux density deteriorates and brittleness increases, and when a certain amount or more is added, cold rolling becomes impossible, thereby making commercial production impossible. In particular, the thinner the thickness of the electrical steel sheet, the better the high-frequency iron loss, but the deterioration in rollability due to brittleness is a fatal problem.

Depending on the design intention of the motor, electrical steel sheets with improved strength may be used even though the magnetic properties are somewhat deteriorated, but as the method for manufacturing electrical steel sheets for this use includes a method of using precipitation of interstitial elements and a method of reducing the grain size. In order to increase the rotational speed by miniaturizing the motor or to increase the effect of the permanent magnet inserted into the rotor, a rotor made of an electrical steel sheet with significantly improved strength is used even though the magnetic properties of the electrical steel sheet are slightly deteriorated. In this case, when fine precipitates containing interstitial solid elements such as C, N, and S are formed, the effect of increasing the strength is good, but there is a disadvantage that the iron loss is rapidly deteriorated to rather reduce the efficiency of the motor. In addition, the method of reducing the grain size has a disadvantage in that the non-uniformity of the material of the steel sheet increases due to the addition of a non-recrystallization portion, thereby increasing the quality deviation of mass-produced products.

In order to solve the problems, an attempt was made to manufacture a non-oriented electrical steel sheet with excellent magnetism and strength by controlling a cooling rate in a final annealing process, but there is a problem that it is difficult to be applied to the mass-production process due to the increase in material non-uniformity due to the addition of the non-recrystallization portion. In addition, most of previously proposed technologies for simultaneously improving magnetism and strength are not used for reasons such as increased manufacturing cost, decreased productivity and recovery, and lack of improvement effect.

### DISCLOSURE

### Technical Problem

The present invention attempts to provide a non-oriented electrical steel sheet and a method for manufacturing the same. More specifically, an exemplary embodiment of the present invention attempts to provide a non-oriented electrical steel sheet capable of suppressing the formation of fine carbonitrides by appropriately adding Mo, Ti, Nb, and V, and controlling the time in a specific temperature range in a cooling process after final annealing and a method for manufacturing the same.

### Technical Solution

A non-oriented electrical steel sheet according to an exemplary embodiment of the present invention includes 3.3 to 4.0 weight % of Si; 0.4 to 1.5 weight % of Al; 0.2 to 1.0 weight % of Mn; 0.0015 to 0.0040 weight % of C; 0.0005 to 0.0020 weight % of N; 0.0005 to 0.0025 weight % of S; 0.005 to 0.01 weight % of Mo; 0.0005 to 0.0020 weight % of Ti; 0.0005 to 0.0020 weight % of Nb; and 0.0005 to 0.0020 weight % of V, with the remainder including Fe and unavoidable impurities, and satisfies Equation 1 below.

1.75≤([Mo]+[Ti]+[Nb]+[V])/([C]+[N])≤4.00 [Equation 1]

(In Equation 1, [Mo], [Ti], [Nb], [V], [C] and [N] represent the contents (weight %) of Mo, Ti, Nb, V, C and N, respectively.)

The non-oriented electrical steel sheet according to an exemplary embodiment of the present invention may have an average grain size of 55 to 80 μm.

In the non-oriented electrical steel sheet according to an exemplary embodiment of the present invention, a distribution density of at least one of carbides, nitrides, and carbonitrides having particle sizes of 50 nm or less may be 0.5 number/mm² or less.

Values calculated in Equation 2 below may be of 500 to 2000.

[Average grain size (μm)]²×[Distribution density of at least one of carbides, nitrides, and carbonitrides having particle sizes of 50 nm or less (number/mm²)] [Equation 2]

The non-oriented electrical steel sheet according to an exemplary embodiment of the present invention may further include at least one of 0.015 to weight % of Sn; 0.015 to 0.1 weight % of Sb; and 0.005 to 0.05 weight % of P.

The non-oriented electrical steel sheet according to an exemplary embodiment of the present invention may further include at least one of 0.05 weight % or less of Cu; 0.002 weight % or less of B; 0.005 weight % or less of Mg; and 0.005 weight % or less of Zr.

The non-oriented electrical steel sheet according to an exemplary embodiment of the present invention may have the resistivity of 50 μΩ·cm or more.

The non-oriented electrical steel sheet according to an exemplary embodiment of the present invention may have a density of 7.55 g/cm³ or more.

The non-oriented electrical steel sheet according to an exemplary embodiment of the present invention may have a 0.2% offset yield strength (Rp_{0.2}) of 440 MPa or more.

The non-oriented electrical steel sheet according to an exemplary embodiment of the present invention may have a 0.2% offset yield strength (Rp_{0.2}) of 98.5% or more of upper yield strength (ReH).

A method of manufacturing a non-oriented electrical steel sheet according to an exemplary embodiment of the present invention includes preparing a slab including 3.3 to 4.0 weight % of Si; 0.4 to 1.5 weight % of Al; 0.2 to 1.0 weight % of Mn; 0.0015 to 0.0040 weight % of C; 0.0005 to 0.0020 weight % of N; 0.0005 to weight % of S; 0.005 to 0.01 weight % of Mo; 0.0005 to 0.0020 weight % of Ti; 0.0005 to 0.0020 weight % of Nb; and 0.0005 to 0.0020 weight % of V, with the remainder including Fe and unavoidable impurities, and satisfying Equation 1 below; preparing a hot-rolled sheet by hot-rolling the slab; cold-rolling the hot-rolled sheet to prepare a cold-rolled sheet; and final annealing the cold-rolled sheet.

1.75≤([Mo]+[Ti]+[Nb]+[V])/([C]+[N])≤4.00 [Equation 1]

(In Equation 1, [Mo], [Ti], [Nb], [V], [C] and [N] represent the contents (weight %) of Mo, Ti, Nb, V, C and N, respectively.)

The final annealing step may include cracking the cold-rolled sheet at a cracking temperature of 910° C. to 1000° C. and cooling the cold-rolled sheet from the cracking temperature to 600° C. within 25 seconds.

The method of manufacturing the non-oriented electrical steel sheet may further include annealing the hot-rolled sheet at a temperature of 850 to 1150° C., after the preparing the hot-rolled sheet.

The final annealing step may be performed in an atmosphere in which hydrogen (H₂) and nitrogen (N₂) are mixed.

### Advantageous Effects

According to an exemplary embodiment of the present invention, it is possible to contribute to improving the performance of drive motors of eco-friendly vehicles by providing a non-oriented electrical steel sheet with improved magnetism and strength.

### DESCRIPTION OF THE DRAWINGS

FIG. 1 is a graph showing a temperature in a final annealing process in an exemplary embodiment of the present invention.

FIG. 2 is a TEM photograph of a cross section measured in steel type B1.

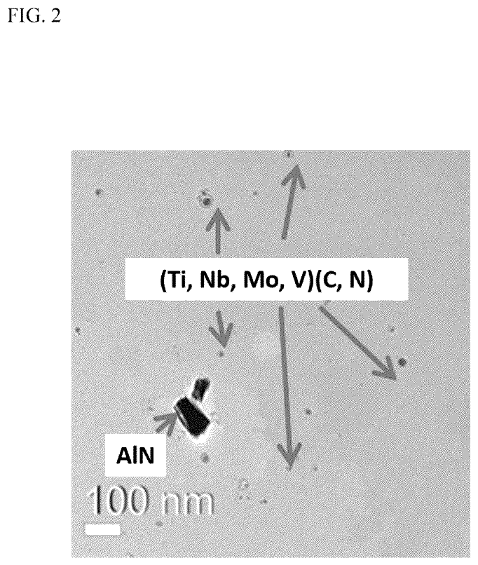

FIG. 3 is a TEM photograph of a cross section measured in steel type B3.

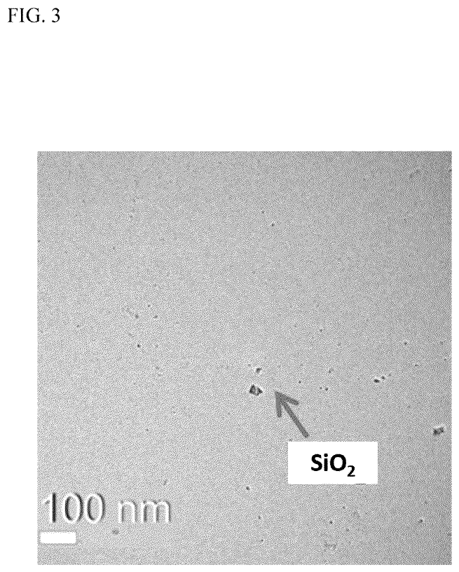

### MODE FOR INVENTION

Terms such as first, second and third are used to describe various parts, components, regions, layers and/or sections, but are not limited thereto. These terms are only used to distinguish one part, component, region, layer or section from another part, component, region, layer or section. Accordingly, a first part, component, region, layer or section to be described below may be referred to as a second part, component, region, layer or section without departing from the scope of the present invention.

The terms used herein is for the purpose of describing specific exemplary embodiments only and are not intended to be limiting of the present invention. The singular forms used herein include plural forms as well, if the phrases do not clearly have the opposite meaning. The “comprising” used in the specification means that a specific feature, region, integer, step, operation, element and/or component is embodied and other specific features, regions, integers, steps, operations, elements, components, and/or groups are not excluded.

When a part is referred to as being “above” or “on” the other part, the part may be directly above or on the other part or may be followed by another part therebetween. In contrast, when a part is referred to as being “directly on” the other part, there is no intervening part therebetween.

In addition, unless otherwise specified, % means weight %, and 1 ppm is weight %.

In an exemplary embodiment of the present invention, the meaning of further including an additional element means replacing and including iron (Fe), which is the remainder by an additional amount of an additional element.

Unless defined otherwise, all terms including technical and scientific terms used herein have the same meaning as commonly understood by those skilled in the art to which the present invention belongs. Commonly used predefined terms are further interpreted as having a meaning consistent with the relevant technical literature and the present invention, and are not to be construed as ideal or very formal meanings unless defined otherwise.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

A non-oriented electrical steel sheet according to an exemplary embodiment of the present invention includes 3.3 to 4.0 weight % of Si; 0.4 to 1.5 weight % of Al; 0.2 to 1.0 weight % of Mn; 0.0015 to 0.0040 weight % of C; 0.0005 to 0.0020 weight % of N; 0.0005 to 0.0025 weight % of S; 0.005 to 0.01 weight % of Mo; 0.0005 to 0.0020 weight % of Ti; 0.0005 to 0.0020 weight % of Nb; and to 0.0020 weight % of V, with the remainder including Fe and unavoidable impurities.

Hereinafter, a reason for limiting the components of the non-oriented electrical steel sheet will be described.

Si: 3.30 to 4.00 weight %

Silicon (Si) serves to increase the resistivity of the material, lower iron loss, and increase strength by solid solution hardening. If too little Si is added, an effect of improving iron loss and strength may be insufficient. When too much Si is added, brittleness of the material is increased so that rolling productivity is rapidly decreased, and an oxide layer and an oxide in the surface layer that are harmful to magnetism are formed, which may be a problem. Accordingly, Si may be included in an amount of 3.3 to 4.0 weight %. More specifically, Si may be included in an amount of 3.4 to 3.6 weight %.

Al: 0.40 to 1.50 weight %

Aluminum (Al) serves to increase the resistivity of the material, lower iron loss, and increase strength by solid solution hardening. If too little Al is added, it may be difficult to obtain a magnetic improvement effect because fine nitrides are formed or a surface oxide layer is not formed densely. If too much Al is added, nitride is excessively formed to deteriorate magnetism and cause problems in all processes such as steelmaking and continuous casting, thereby greatly reducing productivity. Accordingly, Al may be included in an amount of 0.4 to 1.5 weight %. More specifically, Al may be included in an amount of 0.5 to 1.0 weight %.

Mn: 0.20 to 1.00 weight %

Manganese (Mn) serves to increase the resistivity of the material to improve iron loss and form sulfides. If too little Mn is added, MnS is formed finely to cause magnetic deterioration, and if too much Mn is added, fine MnS is excessively precipitated and the formation of a {111} texture against magnetism is made, resulting in a rapid decrease in magnetic flux density. Accordingly, Mn may be included in an amount of 0.2 to 1.0 weight %. More specifically, Mn may be included in an amount of 0.30 to 0.70 weight %.

C: 0.0015 to 0.0040 weight %

Carbon (C) causes magnetic aging and is combined with other impurity elements to form carbides and serves to improve strength by deteriorating magnetic characteristics or interfering with potential shift. If too little C is added, the strength improving effect may be insufficient. If too much C is added, fine carbides may increase and the magnetism may deteriorate rapidly. Accordingly, C may be included in an amount of 0.0015 to 0.0040 weight %. More specifically, C may be included in an amount of 0.0020 to 0.0038 weight %.

N: 0.0005 to 0.0020 weight %

Nitrogen (N) not only forms fine AlN precipitates inside a base material, but also forms fine precipitates in combination with other impurities to inhibit grain growth, thereby deteriorating iron loss or improving strength. If too little nitrogen is added, the strength may not be sufficiently improved. If too much nitrogen is added, fine nitrides may increase and iron loss may deteriorate rapidly. Accordingly, N may be included in an amount of 0.0005 to 0.0020 weight %. More specifically, N may be included in an amount of 0.0008 to 0.0018 weight %.

S: 0.0005 to 0.0025 weight % Since S deteriorates magnetic properties and hot workability by forming fine precipitates such as MnS and CuS, it is preferable to be managed at a low level. However, if too little S is added, the magnetic flux density may decrease. Accordingly, S may be included in an amount of 0.0005 to 0.0025 weight %. More specifically, S may be included in an amount of 0.0010 to 0.0023 weight %.

Mo: 0.0050 to 0.0100 weight %

Molybdenum (Mo) serves to suppress the development of {111} texture harmful to magnetism by segregating at grain boundaries during annealing, and improve strength by forming fine carbides during cooling. If too little Mo is added, the effect thereof may be insufficient. If too much Mo is added, the carbide formation is promoted to degrade magnetism. Accordingly, Mo may be included in an amount of 0.005 to 0.01 weight %. More specifically, Mo may be included in an amount of 0.0060 to 0.0090 weight %.

Ti, Nb, V: Each 0.0005 to 0.0020 weight %

Titanium (Ti), niobium (Nb), and vanadium (V) have a very strong tendency to form precipitates in steel, and degrades iron loss by forming fine carbides, nitrides, or sulfides inside the base material to suppress grain growth and domain wall motion. Accordingly, it is necessary to properly adjust the upper limits of Ti, Nb, and V. On the other hand, if Ti, Nb, and V are included too little, the strength of an electrical steel sheet may be significantly lowered. Therefore, each of Ti, Nb and V may be included in an amount of 0.0005 to 0.0020 weight %. More specifically, each of Ti, Nb and V may be included in an amount of 0.0007 to 0.0018 weight %.

Ti+Nb+V: 0.0030 to 0.0050 weight %

As described above, since Ti, Nb, and V serve to enhance strength, it is preferable to include the total amount of 0.0030 weight % or more. When Ti, Nb, and V are included too much, fine carbides, nitrides, or sulfides are formed to suppress grain growth and domain wall motion, thereby deteriorating iron loss.

The non-oriented electrical steel sheet according to an exemplary embodiment of the present invention satisfies Equation 1 below.

1.75≤([Mo]+[Ti]+[Nb]+[V])/([C]+[N])≤4.00 [Equation 1]

(In Equation 1, [Mo], [Ti], [Nb], [V], [C] and [N] represent the contents (weight %) of Mo, Ti, Nb, V, C and N, respectively.)

When Equation 1 is satisfied, the formation of fine carbonitrides may be minimized. That is, within the range of 1.75 to 4.00, the formation of fine carbonitrides is suppressed and the distribution density of carbonitrides is minimized, and thus the non-oriented electrical steel sheet may be managed within this range. If the value in Equation 1 is too low, there may be a problem in terms of strength. More specifically, the value of Equation 1 may be 2.00 to 3.50.

The non-oriented electrical steel sheet according to an exemplary embodiment of the present invention may further include at least one of 0.015 to 0.1 weight % of Sn; 0.015 to 0.1 weight % of Sb; and 0.005 to 0.05 weight % of P.

Sn, Sb: Each 0.015 to 0.100 weight %

Tin (Sn) and antimony (Sb) segregate on the surface and grain boundaries of the steel sheet to suppress surface oxidation during annealing, hinder the diffusion of elements through grain boundaries, and hinder recrystallization of {111}//ND orientation, thereby improving the texture. If too little Sn and Sb are added, the aforementioned effect may not be sufficient.

When too much Sn and Sb are added, toughness is lowered due to an increase in grain boundary segregation, and thus, productivity may be lowered compared to magnetic improvement. Accordingly, each of Sn and Sb may be further included in an amount of 0.015 to 0.100 weight %. More specifically, each of Sn and Sb may be further included in an amount of 0.020 to 0.075 weight %.

P: 0.005 to 0.050 weight %

Phosphorus (P) segregate on the surface and grain boundaries of the steel sheet to suppress surface oxidation during annealing, hinder the diffusion of elements through grain boundaries, and hinder recrystallization of {111}//ND orientation, thereby improving the texture. If too little P is added, the effect may not be sufficient. If too much P is added, hot working properties may be deteriorated, and thus productivity may be lowered compared to magnetic improvement. Accordingly, P may be further included in an amount of 0.005 to 0.050 weight %. More specifically, P may be further included in an amount of 0.007 to 0.045 weight %.

The non-oriented electrical steel sheet according to an exemplary embodiment of the present invention may further include at least one of 0.01 weight % or less of Cu; 0.002 weight % or less of B; 0.005 weight % or less of Mg; and 0.005 weight % or less of Zr.

Cu: 0.05 weight % or less

Copper (Cu) is an element capable of forming sulfides at high temperatures, and an element that causes defects in the surface during manufacture of slabs when added in large amounts. Accordingly, when Cu is further included, Cu may be included in an amount of 0.05 weight % or less. More specifically, Cu may be included in an amount of 0.001 to 0.05 weight %.

B: 0.002 weight % or less, Mg: 0.005 weight % or less and Zr: 0.005 weight % or less

B, Mg, and Zr are elements that adversely affect magnetism, and each of B, Mg, and Zr may be further included within the aforementioned range.

The remainder includes Fe and unavoidable impurities. The unavoidable impurities are impurities to be added during the steelmaking step and the manufacturing process of the oriented electrical steel sheet, and since the unavoidable impurities are well known in the art, a detailed description thereof will be omitted. In an exemplary embodiment of the present invention, the addition of elements other than the above-described alloy components is not excluded, and may be variously included within a range without impairing the technical spirit of the present invention. Additional elements are further included by replacing the remainder Fe.

The non-oriented electrical steel sheet according to an exemplary embodiment of the present invention has an average grain size of 55 to 80 μm. If the average grain size is too small, iron loss may be degraded. If the average grain size is too large, the strength may be weakened. More specifically, the average grain size may be 58 μm to 75 μm.

In the non-oriented electrical steel sheet according to an exemplary embodiment of the present invention, a density of at least one of carbides, nitrides, and carbonitrides having particle sizes of 50 nm or less is 0.5 number/mm² or less.

In an exemplary embodiment of the present invention, while containing Mo, Ti, Nb, V, C, and N at predetermined contents or more, by adding the contents of Mo, Ti, Nb, and V in a relatively appropriate amount to the contents of C and N, and adjusting the cooling time in the final annealing process, the density of carbides, nitrides, or carbonitrides (hereinafter, also referred to collectively as “carbonitrides”) may be reduced as much as possible. The lower limit of the grain size of carbonitride may be 5 nm. Carbonitrides having smaller than the aforementioned grain size may have no substantial effect on magnetism. The grain size may mean the grain size of a circle assuming a virtual circle having the same area as that of the carbonitride when observing the steel sheet. The measurement faces of the carbonitride may be a surface (ND face) or cross sections (TD face and RD face). The carbonitrides may be observed using TEM. The carbonitride means a particle-shaped portion with a high content of C and/or N compared to the base material of the steel sheet.

The distribution density of the carbonitride may be 0.5 number/mm² or less. More specifically, the distribution density may be 0.05 to 0.50 number/mm². More specifically, the distribution density may be 0.10 to 0.40 number/mm². When carbides, nitrides, or carbonitrides are simultaneously included, the distribution density may be a distribution density of the sum of these.

The non-oriented electrical steel sheet according to an exemplary embodiment of the present invention may have values of 500 to 2000 in Equation 2 below.

[Average grain size (μm)]²×[Distribution density of at least one of carbides, nitrides, and carbonitrides having particle sizes of 50 nm or less (number/mm²)] [Equation 2]

When the values of Equation 2 satisfy 500 to 2000, it is possible to improve the strength while improving the magnetism.

The non-oriented electrical steel sheet according to an exemplary embodiment of the present invention may have the resistivity of 50 μΩ·cm or more. More specifically, the resistivity may be 53 μΩ·cm or more. More specifically, the resistivity may be 58 μΩ·cm or more. The upper limit is not particularly limited, but may be 100 μΩ·cm or less.

The non-oriented electrical steel sheet according to an exemplary embodiment of the present invention may have a density of 7.55 g/cm³ or more. In an exemplary embodiment of the present invention, it is possible to obtain improved strength while having an appropriate density. Specifically, the density may be 7.55 to 8.00 g/cm³.

The non-oriented electrical steel sheet according to an exemplary embodiment of the present invention has excellent strength and magnetism. Specifically, the non-oriented electrical steel sheet according to an exemplary embodiment of the present invention may have a 0.2% offset yield strength (Rp_{0.2}) of 440 MPa or more. When the motor rotates at a high speed, strong stress is applied along a direction from the inside to the outside of the motor. In particular, in the case of a permanent magnet-inserted motor, the efficiency may be improved by disposing the permanent magnet at the distal end of a rotor, but when an electrical steel sheet having a low yield strength is used, the permanent magnet inserted into the rotor causes deformation and destruction of the distal end of the rotor by centrifugal force when the motor rotates, which may cause a problem in durability. For this reason, the mechanical properties of the steel sheet are important, which may be confirmed through the 0.2% offset yield strength (Rp_{0.2}). More specifically, the 0.2% offset yield strength (Rp_{0.2}) may be 440 to 460 MPa.

In addition, in an exemplary embodiment of the present invention, even if tension is applied, the yield strength is reduced to a small extent compared to before tension is applied, so that the strength of the motor may be maintained even if the motor rotates at a high speed. Specifically, the 0.2% offset yield strength (Rp_{0.2}) may be 98.5% or more of upper yield strength (ReH). More specifically, the 0.2% offset yield strength (Rp_{0.2}) may be 98.5% to 99.9% of the upper yield strength (ReH). The yield strength may be measured in accordance with the ISO6892 standard by performing a tensile test with a specimen having a parallel length of 80 mm and measuring the yield strength with 0.2% tension or no tension, respectively.

The non-oriented electrical steel sheet according to an exemplary embodiment of the present invention may have a magnetic flux density (B50) of 1.66 T or more. In this case, B50 means the magnetic flux density induced in a magnetic field of 5000 A/m. More specifically, the magnetic flux density (B50) may be 1.67 to 1.70 T.

The non-oriented electrical steel sheet according to an exemplary embodiment of the present invention may have iron loss (W10/400) of 12.0 W/kg or less. W10/400 means iron loss when a magnetic flux density of 1.0 T is left at a frequency of 400 Hz. More specifically, the iron loss (W10/400) may be 10.5 to 11.5 W/kg. A measurement standard thickness of iron loss may be 0.30 mm.

A method of manufacturing a non-oriented electrical steel sheet according to an exemplary embodiment of the present invention includes the steps of preparing a slab; preparing a hot-rolled sheet by hot-rolling the slab; cold-rolling the hot-rolled sheet to prepare a cold-rolled sheet and final annealing the cold-rolled sheet.

Hereinafter, each step will be described in detail.

First, the slab is prepared.

Since the alloy components of the slab have been described in the alloy components of the aforementioned non-oriented electrical steel sheet, overlapping descriptions will be omitted. Since alloy components are not substantially changed during the manufacturing process of the non-oriented electrical steel sheet, the alloy components of the non-oriented electrical steel sheet and the slab are substantially the same.

Specifically, the slab includes 3.3 to 4.0 weight % of Si; 0.4 to 1.5 weight % of Al; 0.2 to 1.0 weight % of Mn; 0.0015 to 0.0040 weight % of C; 0.0005 to 0.0020 weight % of N; 0.0005 to 0.0025 weight % of S; 0.005 to 0.01 weight % of Mo; 0.0005 to 0.0020 weight % of Ti; 0.0005 to 0.0020 weight % of Nb; and 0.0005 to 0.0020 weight % of V, with the remainder including Fe and unavoidable impurities, and may satisfy the following Equation 1.

1.75≤([Mo]+[Ti]+[Nb]+[V])/([C]+[N])≤4.00 [Equation 1]

(In Equation 1, [Mo], [Ti], [Nb], [V], [C] and [N] represent the contents (weight %) of Mo, Ti, Nb, V, C and N, respectively.)

The slab preparing process may be performed by a process known in the art.

After preparing the slab, the slab may be heated. Specifically, the slab may be charged to a heating furnace and heated to a temperature of 1,200° C. or less. If the slab heating temperature is too high, precipitates such as AlN and MnS present in the slab are re-dissolved and then finely precipitated during hot rolling and annealing to suppress grain growth and reduce magnetism.

Next, the hot-rolled sheet is manufactured by hot-rolling the slab. The thickness of the hot-rolled sheet may be 2 to 2.3 mm. In the step of manufacturing the hot-rolled sheet, the finish rolling temperature may be 800° C. or higher. Specifically, the finish rolling temperature may be 800° C. to 1000° C. The hot-rolled sheet may be wound at a temperature of 700° C. or lower.

After the step of preparing the hot-rolled sheet, the step of annealing the hot-rolled sheet may be further included. In this case, the annealing temperature of the hot-rolled sheet may be 850 to 1150° C. If the annealing temperature of the hot-rolled sheet is too low, the structure does not grow or grows finely, so that it is not easy to obtain a texture favorable to magnetism during annealing after cold rolling. If the annealing temperature is too high, self-grains may grow excessively and surface defects of the sheet may become excessive. The annealing of the hot-rolled sheet is performed to increase orientation favorable to magnetism, if necessary, and can be omitted. The annealed hot-rolled sheet may be pickled. More specifically, the annealing temperature of the hot-rolled sheet may be 950 to 1150° C.

Next, the hot-rolled sheet is cold-rolled to prepare the cold-rolled sheet. In this case, the rolling may be performed by adjusting the reduction ratio to 70 to 85%. If necessary, the cold rolling step may include one cold rolling step or two or more cold rolling steps with intermediate annealing interposed therebetween. In this case, the intermediate annealing temperature may be 850 to 1150° C. The cold-rolled sheet may have a thickness of 0.10 to 0.35 mm.

Next, the cold-rolled sheet is subjected to final annealing. In the process of annealing the cold-rolled sheet, the annealing temperature is not particularly limited as long as the temperature is generally applied to the non-oriented electrical steel sheet. Since the iron loss of the non-oriented electrical steel sheet is closely related to the grain size, the cold-rolled sheet may be annealed at a cracking temperature Tₘₐₓ of 910 to 1000° C. In this case, the cracking temperature means a state in which there is almost no temperature fluctuation. In addition, the cracking time may be annealed for a short time of 100 seconds or less.

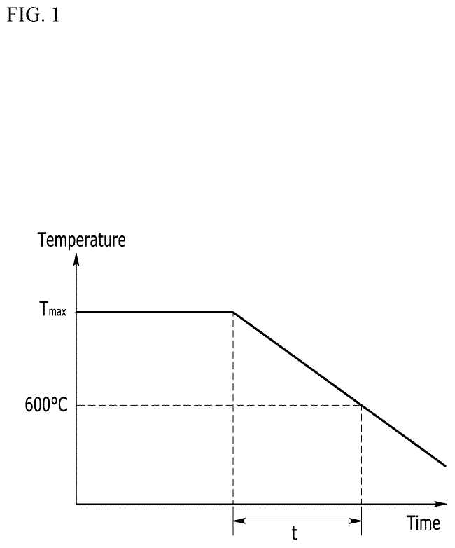

Thereafter, the cooling is performed within 25 seconds (t) from the cracking temperature Tₘₐₓ to 600° C. By cooling in such a short time, it is possible to suppress generation of fine carbonitride as much as possible and suppress irregular growth of grains. More specifically, the cooling is performed within 15 to 23 seconds (t) from the cracking temperature Tₘₐₓ to 600° C. FIG. 1 schematically illustrates the cracking temperature and cooling time (t) according to an exemplary embodiment of the present invention.

The final annealing step may be performed in an atmosphere in which hydrogen (H₂) and nitrogen (N₂) are mixed. Specifically, the annealing may be performed in an atmosphere containing 5 to 40 volume % of hydrogen and 60 to 95 volume % of nitrogen. Annealing in the atmosphere has an advantage of preventing the formation of fine oxides harmful to magnetism that may be formed at high temperature.

In the final annealing process, the average grain size may be 55 to 80 μm, and all (i.e., 99% or more) of the processed structure formed in the previous cold rolling step may be recrystallized.

After final annealing, an insulating film may be formed. The insulating film may be treated with organic, inorganic, and organic/inorganic composite films, and may be treated with other insulating films.

Hereinafter, the present invention will be described in more detail with reference to the following Examples. However, these Examples are only for exemplifying the present invention, and the present invention is not limited thereto.

### Example 1

A slab was prepared from Table 1 and components including the remainder Fe and unavoidable impurities. The slab was heated at 1,150° C. and hot-rolled at a finishing temperature of 880° C. to prepare a hot-rolled sheet having a thickness of 2.0 mm. The hot-rolled sheet was annealed through hot rolling at 1020° C. for 100 seconds, and then cold-rolled to a thickness of 0.25 mm. The cold-rolled sheet was subjected to final annealing at a temperature of Table 2 for 100 seconds.

Table 2 showed calculated values of Relation 1 for each specimen, cooling time from cracking temperature to 600° C. during final annealing, distribution density of (Mo, Ti, Nb, V)(C,N) precipitates with diameters of 50 nm or less, average grain size, upper yield strength (ReH), 0.2% offset yield strength (Rp_{0.2}), Rp_{0.2}/ReH and magnetic properties. The content of each component was measured by an ICP wet analysis method. The cooling time from a highest temperature to 600° C. was measured by directly measuring a sheet temperature by attaching TC to the surface of the specimen. For the precipitates, a TEM specimen was prepared by a replica method, an area of 0.5 mm² or more was measured at high magnification, and carbides or nitrides with a diameter of 50 nm or less and containing one of Mo, Ti, Nb, and V were found, and then the distribution density was calculated by dividing the number by the observed area. The grain size was calculated as (measurement area÷ number of grains)\hat{ }0.5 by abrading and etching the cross-section of the specimen in a vertical direction of rolling, and photographing an area sufficient to contain 1500 or more grains with an optical microscope. For the yield strength, a tensile test was performed with a specimen having a parallel length of 80 mm based on the ISO6892 standard, and the result values were shown. For magnetic properties such as magnetic flux density and iron loss, 60 mm wide×60 mm long×5 sheets of specimens were cut, respectively, and rolling direction and rolling vertical direction were measured with a single sheet tester, and the average values were shown.

TABLE 1

| | | | | | | | | | | | Ti + |
|---|---|---|---|---|---|---|---|---|---|---|---|
| Specimen | | | Mn | C | N | S | Ti | Nb | V | Mo | Nb + V |
| No. | Si [%] | Al [%] | [%] | [ppm] | [ppm] | [ppm] | [ppm] | [ppm] | [ppm] | [ppm] | [ppm] |
| A1 | 3.3 | 1.0 | 0.6 | 38 | 17 | 17 | 7 | 7 | 8 | 69 | 22 |
| A2 | 3.3 | 1.0 | 0.6 | 33 | 14 | 17 | 10 | 7 | 7 | 76 | 24 |
| A3 | 3.3 | 1.0 | 0.6 | 20 | 17 | 23 | 8 | 17 | 11 | 81 | 36 |
| A4 | 3.3 | 1.0 | 0.6 | 25 | 8 | 10 | 15 | 18 | 17 | 65 | 50 |
| B1 | 3.4 | 0.6 | 0.7 | 37 | 17 | 16 | 16 | 9 | 14 | 83 | 39 |
| B2 | 3.4 | 0.6 | 0.7 | 19 | 9 | 8 | 16 | 14 | 15 | 71 | 45 |
| B3 | 3.4 | 0.6 | 0.7 | 33 | 15 | 11 | 17 | 14 | 9 | 75 | 40 |
| B4 | 3.4 | 0.6 | 0.7 | 27 | 8 | 21 | 9 | 12 | 15 | 73 | 36 |
| C1 | 3.5 | 0.8 | 0.2 | 31 | 14 | 12 | 8 | 11 | 7 | 63 | 26 |
| C2 | 3.5 | 0.8 | 0.2 | 19 | 11 | 17 | 17 | 18 | 16 | 81 | 51 |
| C3 | 3.5 | 0.8 | 0.2 | 34 | 14 | 16 | 16 | 9 | 12 | 61 | 37 |
| C4 | 3.5 | 0.8 | 0.2 | 26 | 14 | 14 | 10 | 18 | 9 | 64 | 37 |
| D1 | 3.6 | 0.4 | 0.4 | 19 | 17 | 18 | 9 | 14 | 7 | 85 | 30 |
| D2 | 3.6 | 0.4 | 0.4 | 37 | 18 | 12 | 9 | 7 | 8 | 65 | 24 |
| D3 | 3.6 | 0.4 | 0.4 | 37 | 9 | 10 | 14 | 16 | 14 | 80 | 44 |
| D4 | 3.6 | 0.4 | 0.4 | 27 | 18 | 17 | 17 | 7 | 7 | 62 | 31 |
| D5 | 3.6 | 0.4 | 0.4 | 28 | 16 | 17 | 3 | 2 | 3 | 82 | 8 |
| D6 | 3.6 | 0.4 | 0.4 | 31 | 15 | 17 | 16 | 9 | 7 | 30 | 32 |

TABLE 2

| | | | | | Tₘₐₓ → | Carbonitride | | |
|---|---|---|---|---|---|---|---|---|
| | | | | | 600° C. | Distribution | | |
| | | Resistivity | | | cooling | Density | Grain | |
| Specimen | Density | [μΩ · | Equation | Cracking | time | [number/ | size | Equation 2 |
| No. | [g/cm³] | cm] | 1 | temperature | [sec] | mm²] | [μm] | value |
| A1 | 7.56 | 62.7 | 1.65 | 950 | 19 | 0.28 | 59 | 974.68 |
| A2 | 7.56 | 62.7 | 2.13 | 1020 | 22 | 0.25 | 92 | 2116 |
| A3 | 7.56 | 62.7 | 3.16 | 950 | 17 | 0.24 | 71 | 1209.84 |
| A4 | 7.56 | 62.7 | 3.48 | 950 | 23 | 0.13 | 69 | 618.93 |
| B1 | 7.60 | 60.2 | 2.26 | 950 | 31 | 0.73 | 65 | 3084.25 |
| B2 | 7.60 | 60.2 | 4.14 | 950 | 20 | 0.67 | 73 | 3570.43 |
| B3 | 7.60 | 60.2 | 2.40 | 950 | 15 | 0.35 | 67 | 1571.15 |
| B4 | 7.60 | 60.2 | 3.11 | 950 | 14 | 0.12 | 71 | 604.92 |
| C1 | 7.57 | 60.5 | 1.98 | 950 | 33 | 0.68 | 64 | 2785.28 |
| C2 | 7.57 | 60.5 | 4.40 | 950 | 19 | 0.81 | 74 | 4435.56 |
| C3 | 7.57 | 60.5 | 2.04 | 950 | 20 | 0.14 | 70 | 686 |
| C4 | 7.57 | 60.5 | 2.53 | 950 | 17 | 0.18 | 58 | 605.52 |
| D1 | 7.61 | 58.1 | 3.19 | 900 | 22 | 0.15 | 48 | 345.6 |
| D2 | 7.61 | 58.1 | 1.62 | 950 | 15 | 0.14 | 63 | 555.66 |
| D3 | 7.61 | 58.1 | 2.70 | 950 | 16 | 0.28 | 75 | 1575 |
| D4 | 7.61 | 58.1 | 2.07 | 950 | 23 | 0.12 | 65 | 507 |
| D5 | 7.61 | 58.1 | 2.05 | 950 | 21 | 0.13 | 87 | 983.97 |
| D6 | 7.61 | 58.1 | 1.35 | 950 | 22 | 0.11 | 84 | 776.16 |

TABLE 3

| Specimen | ReH | Rp0.2 | Rp0.2/ | W10/400 | | |
|---|---|---|---|---|---|---|
| No. | [MPa] | [MPa] | ReH [%] | [W/kg] | B50 [T] | Note |
| A1 | 455.1 | 445.8 | 98.0 | 11.4 | 1.67 | Comparative |
| | | | | | | Example |
| A2 | 437.1 | 434.0 | 99.3 | 11.1 | 1.67 | Comparative |
| | | | | | | Example |
| A3 | 448.1 | 444.5 | 99.2 | 11.0 | 1.67 | Invention |
| | | | | | | Example |
| A4 | 450.0 | 445.5 | 99.0 | 11.1 | 1.67 | Invention |
| | | | | | | Example |
| B1 | 443.8 | 441.5 | 99.5 | 12.3 | 1.68 | Comparative |
| | | | | | | Example |
| B2 | 441.2 | 438.3 | 99.3 | 12.4 | 1.68 | Comparative |
| | | | | | | Example |
| B3 | 443.8 | 442.0 | 99.6 | 11.1 | 1.68 | Invention |
| | | | | | | Example |
| B4 | 446.6 | 443.0 | 99.2 | 11.3 | 1.68 | Invention |
| | | | | | | Example |
| C1 | 451.7 | 449.0 | 99.4 | 12.3 | 1.67 | Comparative |
| | | | | | | Example |
| C2 | 442.6 | 439.1 | 99.2 | 12.2 | 1.67 | Comparative |
| | | | | | | Example |
| C3 | 450.1 | 446.3 | 99.2 | 11.2 | 1.67 | Invention |
| | | | | | | Example |
| C4 | 455.9 | 452.6 | 99.3 | 11.1 | 1.67 | Invention |
| | | | | | | Example |
| D1 | 459.8 | 454.0 | 98.7 | 12.1 | 1.68 | Comparative |
| | | | | | | Example |
| D2 | 450.1 | 440.3 | 97.8 | 11.3 | 1.68 | Comparative |
| | | | | | | Example |
| D3 | 443.8 | 442.0 | 99.6 | 11.4 | 1.68 | Invention |
| | | | | | | Example |
| D4 | 447.3 | 445.5 | 99.6 | 11.2 | 1.68 | Invention |
| | | | | | | Example |
| D5 | 446.3 | 432.0 | 96.8 | 11.9 | 1.67 | Comparative |
| | | | | | | Example |
| D6 | 448.4 | 433.0 | 96.6 | 11.8 | 1.67 | Comparative |
| | | | | | | Example |

As shown in Tables 1 to 3, it can be confirmed that Examples in which the alloy components are appropriately adjusted and the cooling time during the final annealing is adjusted to be short exhibit high Rp0.2 of 440 MPa or more and excellent magnetic properties because the carbonitride distribution and the grain size are properly controlled. In A1 and D2, it can be confirmed that since the value of Equation 1 is too small, the strength properties are degraded. In B2 and C2, it can be confirmed that since the value of Equation 1 is too large, a large amount of carbonitrides is generated and the magnetism is deteriorated.

In B1 and C1, it can be confirmed that since the cooling time is too long, a large amount of carbonitrides is generated and the magnetism is deteriorated.

In A2, it can be confirmed that since the cracking temperature is too high, the grain size is large, and the strength properties are deteriorated.

In D1, it can be confirmed that since the cracking temperature is too low, the grain size is too small, and both strength and magnetism are deteriorated.

In D5 and D6, it can be confirmed that since the contents of Mo, Ti, Nb, and V are low, both strength and magnetism are deteriorated.

The present invention can be manufactured in various different forms, not limited to the exemplary embodiments, and it will be appreciated to those skilled in the art that the present invention may be implemented in other specific forms without changing the technical idea or essential features of the present invention.

Therefore, it should be appreciated that the exemplary embodiments described above are illustrative in all aspects and are not restricted.

1. A non-oriented electrical steel sheet comprising:
3.3 to 4.0 weight % of Si; 0.4 to 1.5 weight % of Al; 0.2 to 1.0 weight % of Mn; 0.0015 to 0.0040 weight % of C; 0.0005 to 0.0020 weight % of N; 0.0005 to 0.0025 weight % of S; 0.005 to 0.01 weight % of Mo; 0.0005 to 0.0020 weight % of Ti; 0.0005 to 0.0020 weight % of Nb; and 0.0005 to 0.0020 weight % of V, with the remainder including Fe and unavoidable impurities, and,
satisfies Equation 1 below,
wherein an average grain size is 55 μm to 80 μm, and
a distribution density of at least one of carbides, nitrides, and carbonitrides having particle sizes of 50 nm or less is 0.5 number/mm² or less.
1.75≤([Mo]+[Ti]+[Nb]+[V])/([C]+[N])≤4.00 [Equation 1]
(In Equation 1, [Mo], [Ti], [Nb], [V], [C] and [N] represent the contents (weight %) of Mo, Ti, Nb, V, C and N, respectively.)

2. The non-oriented electrical steel sheet of claim 1, wherein
values calculated in Equation 2 below are of 500 to 2000.
[Average grain size (μm)]²×[Distribution density of at least one of carbides, nitrides, and carbonitrides having particle sizes of 50 nm or less (number/mm²)] [Equation 2]

3. The non-oriented electrical steel sheet of claim 1, further comprising:
at least one of 0.015 to 0.1 weight % of Sn; 0.015 to 0.1 weight % of Sb; and 0.005 to 0.05 weight % of P.

4. The non-oriented electrical steel sheet of claim 1, further comprising:
at least one of 0.05 weight % or less of Cu, 0.002 weight % or less of B, 0.005 weight % or less of Mg, and 0.005 weight % or less of Zr.

5. The non-oriented electrical steel sheet of claim 1, wherein
the resistivity is 50 μΩ·cm or more.

6. The non-oriented electrical steel sheet of claim 1, wherein
a density is 7.55 g/cm 3 or more.

7. The non-oriented electrical steel sheet of claim 1, wherein
a 0.2% offset yield strength (Rp_{0.2}) is 440 MPa or more.

8. The non-oriented electrical steel sheet of claim 1, wherein
the 0.2% offset yield strength (Rp_{0.2}) is 98.5% or more of upper yield strength (ReH).

9. A method of manufacturing a non-oriented electrical steel sheet comprising:
preparing a slab comprising 3.3 to 4.0 weight % of Si; 0.4 to 1.5 weight % of Al; 0.2 to 1.0 weight % of Mn; 0.0015 to 0.0040 weight % of C; 0.0005 to 0.0020 weight % of N; 0.0005 to 0.0025 weight % of S; 0.005 to 0.01 weight % of Mo; 0.0005 to 0.0020 weight % of Ti; 0.0005 to 0.0020 weight % of Nb; and 0.0005 to 0.0020 weight % of V, with the remainder including Fe and unavoidable impurities, and satisfying Equation 1 below;
preparing a hot-rolled sheet by hot-rolling the slab;
cold-rolling the hot-rolled sheet to prepare a cold-rolled sheet; and
final annealing the cold-rolled sheet,
wherein the final annealing step includes cracking the cold-rolled sheet at a cracking temperature of 910° C. to 1000° C. and cooling the cold-rolled sheet from the cracking temperature to 600° C. within 25 seconds.
1.75≤([Mo]+[Ti]+[Nb]+[V])/([C]+[N])≤4.00 [Equation 1]
(In Equation 1, [Mo], [Ti], [Nb], [V], [C] and [N] represent the contents (weight %) of Mo, Ti, Nb, V, C and N, respectively.)

10. The method of manufacturing the non-oriented electrical steel sheet of claim 9, further comprising:
annealing the hot-rolled sheet at a temperature of 850 to 1150° C., after the preparing of the hot-rolled sheet.

11. The method of manufacturing the non-oriented electrical steel sheet of claim 9, wherein
the final annealing step is performed in an atmosphere in which hydrogen (H₂) and nitrogen (N₂) are mixed.
